(19) United States
(12) Patent Application Publication
(10) Pub. No.: US 2008/0272937 A1
(43) Pub. Date: Nov. 6, 2008

(54) Low Power Airfield Lighting System

(75) Inventors: Daniel A. That, South Windsor, CT (US); Theodore J. Busky, Storrs, CT (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 11/618,323

(22) Filed: Dec. 29, 2006

Related U.S. Application Data
(60) Provisional application No. 60/806,406, filed on Jun. 30, 2006.
(60) Provisional application No. 60/806,408, filed on Jun. 30, 2006.

(51) Int. Cl. G08G 5/00

(52) U.S. Cl. 340/947; 362/153.1

(57) ABSTRACT

An airfield lighting system including an interface device for driving a light emitting diode including an isolation and step down device, a rectifier, and output terminals is provided.

### CROSS REFERENCE TO RELATED APPLICATION

This application is related to U.S. utility patent application Ser. No. ______, attorney docket No. 23667.538, entitled INTERFACE DEVICE FOR LOW POWER LED AIRFIELD LIGHTING SYSTEMS filed on Dec. 29, 2006, by That, et al., U.S. utility patent application Ser. No. 11/610,141, attorney docket No. 23667.298, entitled AIRFIELD LIGHTING SYSTEM AND METHODS filed on Dec. 13, 2006 by That, U.S. provisional patent application Ser. No. 60/806,406, attorney docket No. 23667.532, entitled POWER SUPPLY FOR LED-BASED AIRFIELD LIGHTING SYSTEM, filed on Jun. 30, 2006 by Kayser, U.S. provisional patent application Ser. No. 60/806,408, attorney docket No. 23667.533, entitled POWER SUPPLY FOR LED-BASED AIRFIELD LIGHTING SYSTEM, filed on Jun. 30, 2006, the disclosures of which are incorporated herein by reference.

### BACKGROUND OF THE INVENTION

Embodiments disclosed herein generally relate to airport and airfield lighting systems and, more particularly, to a low power airport or airfield LED light system.

### BRIEF DESCRIPTION OF THE DRAWINGS

Aspects of the present disclosure are best understood from the following detailed description when read with the accompanying figures.

FIG. 1 is a diagrammatic representation of an exemplary airport layout with four main runways, various taxiways, and an apron in which an airport lighting system may be deployed;

FIG. 2 is a diagrammatic representation of an airfield current loop and power distribution system in which embodiments disclosed herein may be implemented;

FIG. 3 is a block diagram of a configuration for deployment of an interface device in the airfield lighting system depicted in FIG. 2 implemented in accordance with an embodiment;

FIG. 4 is a diagrammatic representation of a configuration for connecting an LED fixture with an airfield constant current loop via an interface device implemented in accordance with an embodiment;

FIG. 5 is a block diagram of an exemplary interface device configuration implemented in accordance with an embodiment;

FIG. 6 is a circuit schematic of an interface device implemented in accordance with an embodiment;

FIG. 7 is a sectional schematic of an interface device packaged in a base that may be deployed in the system depicted in FIG. 2 in accordance with an embodiment;

FIG. 8 is an isometric view of an interface device packaged in a base implemented in accordance with an embodiment; and

FIG. 9 is a circuit schematic of an LED fixture that may be driven via an interface device implemented in accordance with an embodiment.

### DETAILED DESCRIPTION OF THE ILLUSTRATIVE EMBODIMENTS

It is to be understood that the following disclosure provides many different embodiments, or examples for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Light fixtures for airport runways and taxiways often are recessed into the pavement to delineate the centerlines, boundaries, or other areas of the runways taxiway, or other infrastructure and to provide a visual indication of the location of the runway or taxiway. Such a light fixture typically includes a transformer, a base assembly, and a light fixture. The base assembly is positioned in the pavement and holds the transformer. The light fixture is removably positioned within the base assembly. The light fixture may include an optical housing, a bottom cover, a lamp bracket assembly, and a lamp. Typically, the optical housing and the bottom cover together define a watertight housing that contains the lamp bracket assembly and the lamp. A typical airport or airfield will include one or more current loops to which numerous light fixtures are connected in series. Hereinafter, the terms “airport” and “airfield” will include any region, area, or zone designated for aircraft landing, taking off, and taxing.

Deployment of light emitting diodes (LEDs) for airport lighting, such as in-pavement taxiway centerline lighting, may provide numerous advantages over incandescent and other light sources. For example, the use of airport lighting colors are regulated to provide an unambiguous visual indication of the infrastructure that is lighted. Because LEDs are capable of emitting light of a particular color, implementation of LEDs for airport lighting may be made without the use of color filters required for traditional lighting methods. LEDs are less sensitive to vibration and physical impact compared to, for example, incandescent light sources. LEDs are typically manufactured in solid cases that protect the LEDs making the LEDs durable, LEDs have much longer lifespans compared to incandescent and other light sources. Moreover, LEDs generally age slowly rather than the abrupt failure characteristic of incandescent bulbs. Also, LEDs are generally eighty (80) percent more efficient than incandescent lights. For any one or more of the above reasons, it may be preferable to deploy LEDs for various airport lighting systems where installation and replacement of a failed lighting source is inconvenient.

Contemporary LED fixtures deployed in airfield lighting systems comprise power supply electronic circuits and one or more LEDs in a LED fixture. Inclusion of the power supply electronics in the LED fixture disadvantageously increases the cost of the light fixture. Moreover, the power supply electronics included in conventional LED fixtures consume a large amount of power with respect to the power consumption of the LEDs. Embodiments disclosed herein provide for lower power consumption for an LED light system. In one implementation, an interface device is provided that is deployed to couple a LED fixture with a constant current loop. The LED interface device drives the LED fixture directly and thus no secondary power circuitry is included in the LED fixture. Thus, the cost of LED fixtures for deployment in airfield lighting systems is significantly reduced. Moreover, the interface device may be implemented with a transformer for step-down and isolation without the use of expensive power electronics thereby reducing the overall LED lighting system cost and power consumption with respect to conventional LED fixtures and systems.

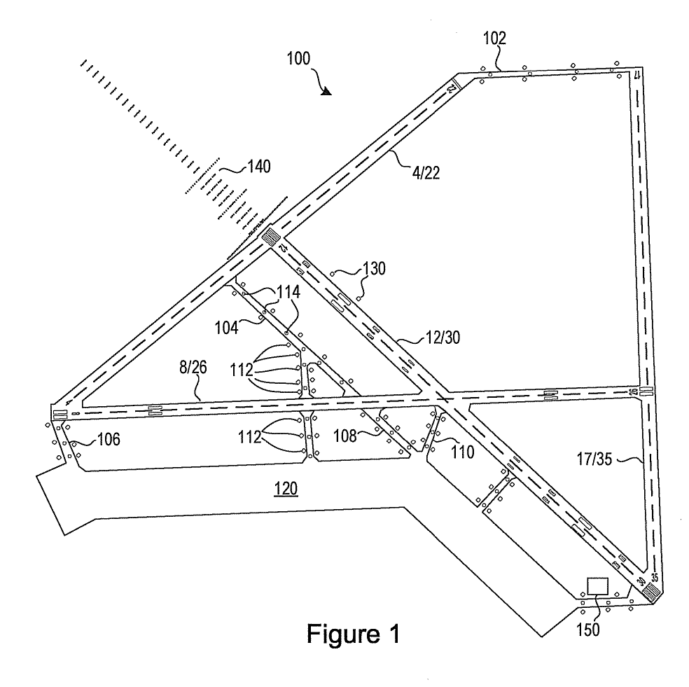

FIG. 1 is a diagrammatic representation of an exemplary airport layout 100 with four main runways 4/22, 8/26, 12/30, and 17/35, various taxiways 102, 104, 106, 108, and 110, and an apron 120 in which an airport lighting system may be deployed. In one exemplary embodiment, the airport lighting system includes light fixtures having light emitting diodes (LEDs). Each runway intended for nighttime operation is equipped with runway edge lights, which are white. On an instrument runway, the last 2,000 feet of the runway is equipped with yellow lights as a cautionary aid. At the ends of each runway, runway end lights emit red light toward the runway and green light away from the runway. Some precision approach runways also contain in-runway centerline lighting, which are white until the last 3,000 feet of the runway, alternate with red for the next 2,000 feet of the runway, and red for the last 1,000 feet of the runway. Taxiway leadoff lights may extend from the runway centerline to a centerline point on an exit taxiway to aid aircraft exiting the runway. Taxiways themselves and the edges of apron 120 that face the runway/taxiway area are identified by blue edge lights 112. Clearance bar and runway guard lights may be illuminated with yellow light. Red stop bar lights may be installed across a taxiway at a runway hold position.

Other airfield lights help the pilots of incoming aircraft identify, and align with, the active runway. These include visual glideslope indicators 130 which help the pilot maintain a proper descent trajectory to the touchdown zone while providing sufficient clearance above off-runway obstacles. One common glideslope indicator 130 is a Precision Approach Path Indicator (PAPI) which comprises two or more light units arranged to one side of the runway in a tandem configuration near the touchdown zone. Each light unit projects a split beams with a white upper half and a red lower half. A pilot that is approaching too low will see light from both units as red. A pilot that is too high will see light from both units as white. A pilot that is maintaining the proper glideslope will see the one light as red and the other lights as white. Also, various Approach Lighting System (ALS) configurations 140 may be deployed in the approach area just beyond the runway threshold. Depending on the configuration, an ALS may comprise tracks and bars of red and white lights and may include sequenced flashing lights that appear as a white light traveling rapidly across the ground towards the active runway threshold twice a second.

Taxiway edge lights 112 are used to outline the edges of taxiways during periods of darkness or restricted visibility conditions. Taxiway edge lights 112 may emit blue light. Taxiway centerline lights 114 are used to facilitate ground traffic under low visibility conditions. Taxiway centerline lights 114 are located along the taxiway centerline in a straight line on straight portions, on the centerline of curved portions, and along designated taxiing paths in portions of runways, ramp, and apron areas. Taxiway centerline lights may emit green and yellow light. Taxiway stop-bar and guard lights emit red and yellow light.

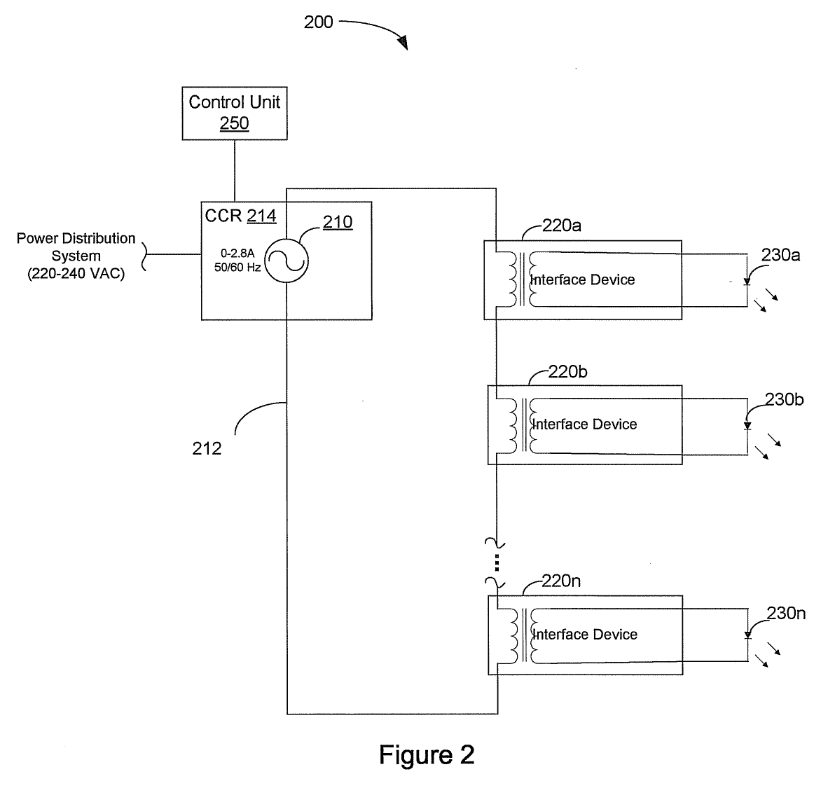

FIG. 2 is a diagrammatic representation of an airfield current loop and power distribution system 200 in which embodiments disclosed herein may be implemented. An alternating current source 210 is deployed in a constant current loop 212 that drives one or more interface devices 220a-220n serially connected in current loop 212. Each interface device 220a-220n directly drives an LED fixture 230a-230n without the use of secondary power circuitry in accordance with embodiments disclosed herein.

Current source 210 may be provided by a constant current regulator 214 that is driven by an external alternating source. In the present example, constant current regulator 214 is powered by an alternating 220-240 volt system, e.g., a power distribution system. Current regulator 214 may, for example, be implemented as a Crouse-Hinds constant current regulator marketed under model number REGF or any one of a variety of other commercially available constant current regulators. Current regulator 214 may include or otherwise interface with one or more transformer modules that each drive a respective current loop. In the illustrative example, a transformer module of constant current regulator 214 may provide a supply current of 0-2.8 A at, for example, 50-60 Hz to constant current loop 212 although current regulator 214 may provide other supply currents dependent on the particular implementation of current regulator 214. In the illustrative example, current regulator 214 is depicted as driving a single current loop to simplify the illustration. In general, current regulator 214 may power multiple current loops. Current regulator 214 may be adapted to provide 3-step, 5-step, or other operational variants to control the lighting intensity of LEDs modules 230a-230n. In one embodiment, current regulator 214 may be configured to step between a minimum current, e.g., 0 A, and a maximum current, e.g., 2.8 A, at any current increment. In a particular embodiment, the current steps configured for current regulator 214 may be implemented such that the light intensity of LED fixtures coupled to current loop 212 produce a linear intensity variation in response to the current regulator steps.

A control unit 250 may be communicatively coupled with current regulator 214 to provide an interface with system 200 for control thereof. In accordance with an embodiment, each of interface devices 220a-220n may include respective isolation and step down functionality for directly driving LED fixtures 230a-230n. Additionally, interface devices 220a-230n may optionally include a lightning protection device as described more fully hereinbelow.

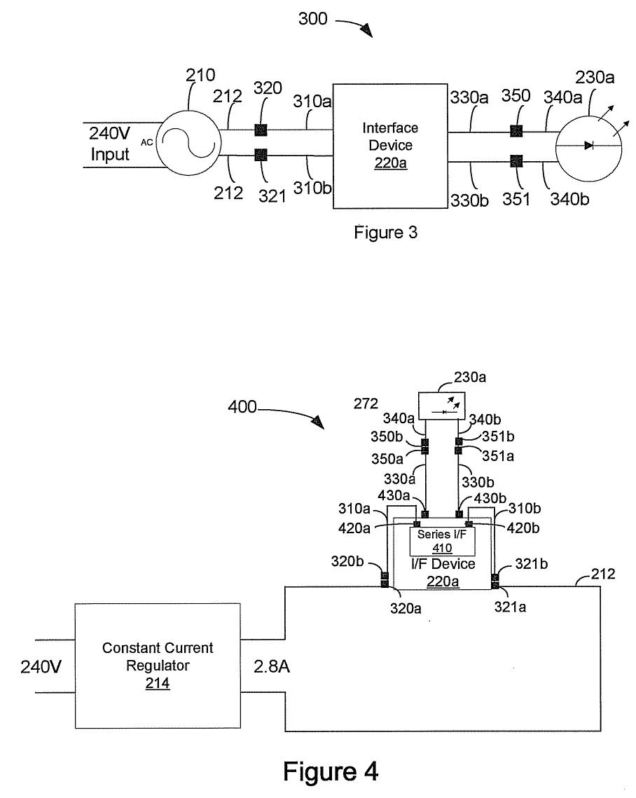

FIG. 3 is a block diagram of a configuration 300 for deployment of an interface device in airfield lighting system 200 implemented in accordance with an embodiment.

Current source 210 supplies a constant current to current loop 212 that connects with primary connector cables 310a and 310b, collectively referred to as primary connector cable 310, of interface device 220a via connection kits 320 and 321. Interface device 220a may include secondary connector cables 330a and 330b, collectively referred to as secondary connector cable 330, that connect with connector cables 340a and 340b, collectively referred to as connector cable 340, of LED fixture 230a via connection kits 350 and 351.

In an embodiment, connection kits 320 and 321 may be implemented as L-824 connectors, and connection kits 350 and 351 may be implemented as L-823 connectors. Accordingly, each pair of connection kits 320, 321 and 350, 351 may be implemented as respective male and female connection couplings although other connection kits may be suitably substituted therefor. Other interfaces devices, such as interface devices 220b-220n, deployed in airfield lighting system 200 may be configured similar to the configuration of interface device 220a depicted in FIG. 3.

FIG. 4 is a diagrammatic representation of a configuration 400 for connecting an LED fixture with an airfield constant current loop via an interface device implemented in accordance with an embodiment.

Constant current regulator 214 is supplied with a power source, such as an alternating 240V source, and outputs a constant current, e.g., 2.8 A, to current loop 212. Current loop 212 includes connection kits 320a and 321a that may couple with connection kits 320b and 321b that terminate interface device 220a primary connector cables 310a and 310b. Primary connector cables 310a and 310b may couple with a series circuit interface 410 of interface device 220a at source terminals 420a and 420b of interface device 220a. In the illustrative example, current loop 212 includes connector kit 320a that may couple with connector kit 320b that terminates primary connector cable 310a. In a similar manner, current loop 212 includes connector kit 321a that may couple with connector kit 321b that terminates primary connector cable 310b. Thus, connector kits 320a and 320b, collectively referred to as connector kit 320, and connector kits 321a and 321b, collectively referred to as connector kit 321, couple interface device 220a to current loop 212 via series circuit interface 410.

Interface device 220a may include output terminals 430a and 430b at which secondary connector cables 330a and 330b may be terminated. Secondary connector cables 330a and 330b may each include a respective connector kit 350a and 351a adapted to couple with connector kits 350b and 351b that terminate connector cables 340a and 340b of LED fixture 230a.

In operation, constant current regulator 214 is powered by an alternating source and drives constant current loop 212 with a particular amperage, e.g., 2.8 A. The current supplied to current loop 212 may be provided to interface device 220a via series circuit interface 410. Interface device 220a may provide isolation and step-down functionality for driving LED fixture 230a as described more fully hereinbelow. A plurality of interface devices and LED fixtures may be series connected with interface device 220a and may be configured in a similar manner as that depicted in FIG. 4.

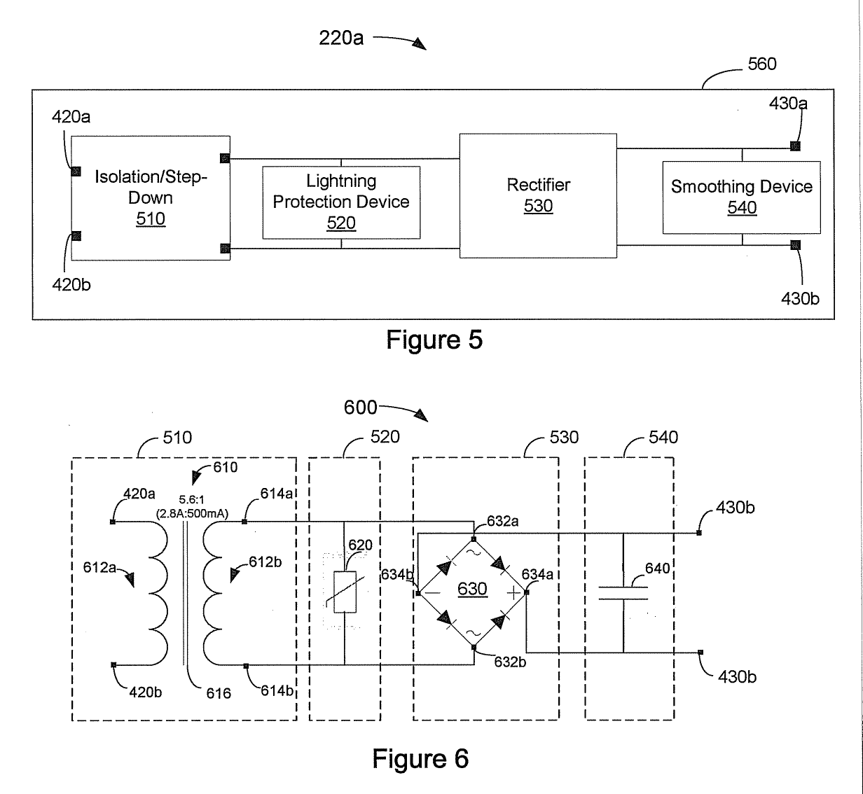

FIG. 5 is a block diagram of an exemplary interface device 220a configuration implemented in accordance with an embodiment. Interface device 220a may include an isolation and step down device 510 that may interface with constant current loop 212 of system 200. In an embodiment, isolation and step down device 510 comprises a transformer with a turns ratio suitable to supply a step down of the current of constant current loop 212 for driving an LED fixture that may be coupled with interface device 220a. Isolation and step down device 510 may include source terminals 420a and 420b that may be coupled with constant current loop 212. Source terminals 420a and 420b comprise power supply input terminals for interface device 220a. Primary connector cables 310a and 310b may be coupled to source terminals 420a and 420b.

In accordance with another embodiment, a lightning protection device 520 may be coupled to an output of isolation and step down device 510. Lightning protection device 520 may generally be implemented as a device or circuit for suppressing large transient or impulse voltages that may be applied to interface device 220a resulting from a lightning strike thereto or to constant current loop 212. In general, lightning protection device 520 functions to shunt excessive currents that may result from a lighting strike or other transient phenomena from an LED fixture that may be coupled with interface device 220a thereby protecting the operational integrity of a lighting system featuring interface device 220a.

Isolation and step down device 510 may be coupled with a rectifier 530 for converting alternating current supplied to an input thereof to a direct current suitable for driving an LED fixture that may be coupled with interface device 220a. To this end, rectifier 530 may be implemented as a bridge rectifier that provides full wave rectification in accordance with an embodiment although a half wave rectifier may alternatively be implemented as described more fully hereinbelow. In the event that interface device 220a includes lightning protection device 520, lightning protection device 520 may be coupled to isolation and step down device 510 in parallel with rectifier 530

In accordance with another embodiment, a smoothing device 540 may optionally be coupled to an output of rectifier 530 to lessen the variation of a voltage waveform output from rectifier 530. To this end, smoothing device 540 may be implemented as a filter capacitor or other device suitable for DC conditioning the output of rectifier 530 such that the DC voltage applied to an LED fixture coupled to output terminals 430a and 430b of interface device 220a is well smoothed.

Interface device 220a may additionally include output terminals 430a and 430b that may be interconnected with an LED fixture base or power supply input via secondary connector cables that may be terminated at output terminals 430a and 430b. Interface device 220a may be packaged in a base 560 that may be insulative and weather proofed. Interface device 220a may be deployed in lighting system 200 by coupling source terminals 420a and 420b with constant current loop 212 via suitable connector cables and connector kits and coupling output terminals 430a and 430b with power supply input terminals of an LED fixture with suitable secondary connector cables and connector kits.

FIG. 6 is a circuit schematic 600 of interface device 220a implemented in accordance with an embodiment.

Interface device 220a may include a transformer 610 implemented as isolation and step down device 510 that provides isolation and step down from current loop 212 of system 200. Transformer 610 may comprise, or alternatively be coupled with, source terminals 420a and 420b of a primary winding 612a and secondary terminals 614a and 614b of a secondary winding 612b through which a voltage is induced via application of an alternating current of current loop 212 to primary winding 612a and a resultant magnetic flux in a magnetic core 616. In an embodiment, transformer 610 has an exemplary turns ratio of 5.6:1, although transformer 610 may be implemented with other turns ratios to accommodate a particular lighting application. Thus, a current of 500 mA may be induced in secondary winding 612b when source terminals 420a and 420b are connected with current loop 212 having a loop current of 2.8 A.

In an embodiment, lightning protection device 520 may be implemented as a varistor 620, such as a metal oxide varistor, and may be coupled across secondary terminals 614a and 614b of transformer 610. Varistor 620 may generally be implemented as a device or circuit for suppressing large transient or impulse voltages that may be applied to interface device 220a resulting from a lightning strike thereto or to constant current loop 212. Varistor 620 functions to shunt excessive currents that may result from a lightning strike or other transient phenomena from an LED fixture that may be coupled with interface device 220a thereby protecting the operational integrity of a lighting system featuring interface device 220a. In other implementations, lightning protection device 520 may be implemented as a transient voltage suppression diode, a spark gap, or other suitable device or circuit.

Secondary terminals 614a and 614b of transformer 610 may be connected with rectifier 530 implemented as a bridge rectifier 630 at respective terminals 632a and 632b thereof. Bridge rectifier 630 provides full wave rectification in accordance with an embodiment and is supplied with an alternating current at terminals 632a and 632b and provides a DC output across output terminals 634a and 634b. In another embodiment, rectifier 530 may be implemented as a half-wave rectifier. If the interface device optionally includes varistor 620, varistor 620 may be coupled to terminals 614a and 614b in parallel with rectifier 630.

In an embodiment, smoothing device 540 may be implemented as a capacitor 640 that may be coupled across rectifier output terminals 634a and 634b. Capacitor 640 functions to smooth or lessen the variation of the output of rectifier 630

Interface device 220a may additionally include output terminals 430a and 430b that may be interconnected with secondary connector cables adapted to couple with an LED fixture base or power supply input cable thereof. Interface device 220a may be packaged in a base or other housing as described more fully hereinbelow.

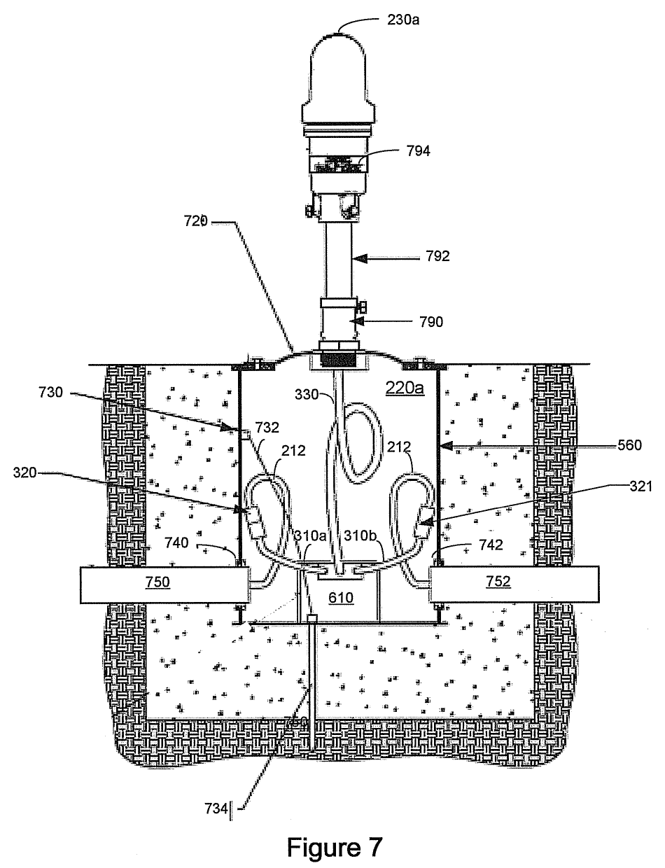

FIG. 7 is a sectional schematic of interface device 220a packaged in base 560 that may be deployed in system 200 in accordance with an embodiment. Base 560 may be implemented as a weather-proofed container that houses the various interface device components. Base 560 may be sealed with a surface base plate 720 that may be threadably coupled with base 560. Base 560 may include a ground lug 730 that terminates a ground wire 732 coupled with a ground rod 734 for earth grounding interface device 220a. Sidewalls of base 560 may include apertures 740 and 742 to which a respective conduit 750 and 752 may be attached. Conduits 750 and 752 may be used to feed conductive cabling of current loop 212 to interface device 220a. Connector kits 320 and 321 may be included in base 560 to series connect current loop 212 with primary connector cables 310a and 310b that may be physically coupled with transformer 610. Base 560 may include secondary connector cable 330 that may be coupled across output terminals 430a and 430b depicted in FIGS. 4-6 of interface device 220a. Secondary connector cable 330 may pass through base plate 720, a breakable coupling 790, an electrical conduit 792 connected with breakable coupling 780, and a fixture support 794 connected with conduit 792 where secondary connector cable 330 is terminated. LED fixture 230a may be removably coupled with fixture support 794 to facilitate installation and replacement of the LED fixture.

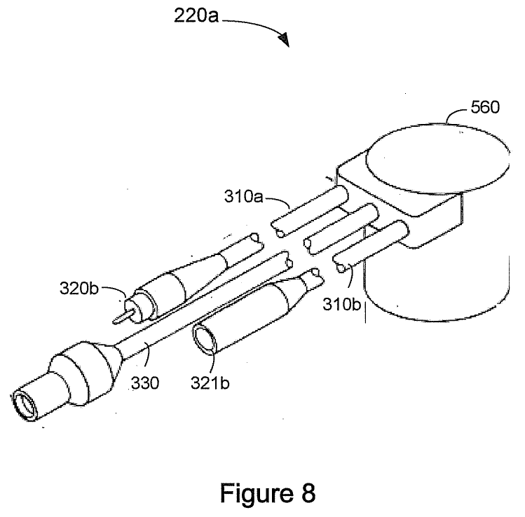

FIG. 8 is an isometric view of interface device 220a packaged in base 560 implemented in accordance with an embodiment. Base 560 provides a housing for various components of interface device 220a. Primary connector cables 310a and 310b may be physically coupled to interface device 220a internally in base 560 and may extend externally therefrom to facilitate coupling of interface device 220a with current loop 212. Primary connector cables 310a and 310b may include connector kits 320b and 321b implemented as a male and female connector adapted to couple with corresponding connectors of current loop 212. Additionally, secondary connector cable 330 may be coupled with interface device 220a and may extend eternally therefrom to facilitate coupling of LED fixture 230a with interface device 220a.

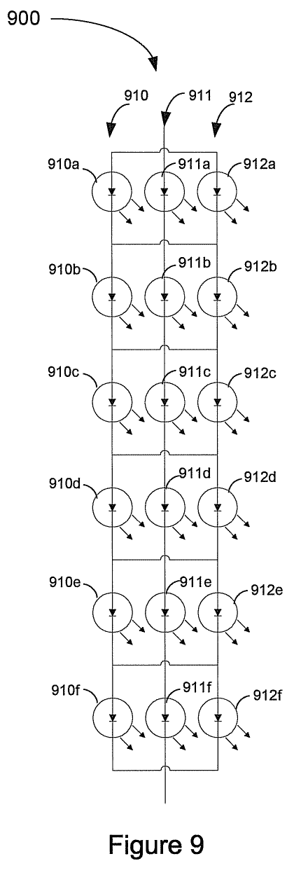

FIG. 9 is a circuit schematic of LED fixture 230a implemented in accordance with an embodiment. In the illustrative example, LED fixture 230a comprises three series connected strings 910-912 of six LEDs each. Particularly, series connected string 910 comprises LEDs 910a-910f, series connected string 911 comprises LEDs 911a-911f, and series connected string 912 comprises LEDs 912a-912f. Secondary connector cable 340 may be coupled with LED fixture 230a for electrically coupling LED fixture 230a with interface device 220a. The particular LED configuration depicted in FIG. 9 is exemplary only, and other configurations of LEDs may be suitably substituted therefor.

As described, an airfield lighting system including an interface device and methods for driving a LED fixture are provided. An interface device may be adapted to couple with a constant current loop of an airfield lighting system and provides isolation and step down therefrom. A LED fixture may couple to a direct current output from the interface device. The interface device provides for rectification of the power supplied to the interface device from the constant current loop. Additionally, the interface device may include a power conditioning or smoothing device that smoothes the rectified output. The interface device may additionally include a lightning protection device that may shunt a current resulting from a lightning strike or other large voltage transient that may be applied to the interface device. The LED interface device is adapted to drive an LED fixture directly and thus no secondary power circuitry is included in the interface device or LED fixture. Thus, the cost of LED fixtures for deployment in airfield lighting systems is significantly reduced and the overall airfield lighting system cost may be reduced.

Accordingly, embodiments disclosed herein provide an airfield lighting system comprising a constant current loop coupled with a current source, a plurality of interface devices removeably coupled in series with the constant current loop, and a plurality of light emitting diode fixtures removeably coupled with a respective interface device of the plurality of interface devices is provided. The plurality of interface devices may step down a current of the constant current loop to an amperage suitable for driving a respective light emitting diode fixture. The system may comprise a constant current regulator that drives the constant current loop. The plurality of interface devices may respectively include a transformer. The transformer is adapted to electrically couple with the constant current loop. The transformer may comprise a turns ratio of substantially 5.6-to-1. The constant current loop may have a current of substantially 2.8 amps supplied to each of the plurality of interface devices. Each of the plurality of interface devices may comprise a respective transformer and a rectifier having input terminals coupled to a secondary winding of the transformer. Each of the plurality of interface devices may comprise a respective smoothing device coupled across terminals of the rectifier. The smoothing device may be adapted to smooth a voltage output from the rectifier. The smoothing device may comprise a capacitor. Each of the plurality of interface devices may comprise a respective lightning protection device coupled in parallel with the light emitting diode fixture coupled thereto. The lightning protection device may be selected from the group consisting of a metal oxide varistor, a transient voltage suppression diode, and a spark gap.

In accordance with another embodiment, an airfield lighting system comprising means for providing a current to a constant current loop, means for removeably coupling interfaces in series with the constant current loop, and means for removeably coupling a plurality of light emitting diode fixtures with the interfaces is provided. The interfaces may step down a current of the constant current loop to an amperage suitable for driving a respective light emitting diode fixture. The system may further comprise a means that regulates a current of the constant current loop. Each of the interfaces may respectively include a transformer means. The transformer means may be adapted to electrically couple with the constant current loop. The transformer means may comprise a turns ratio of substantially 5.6-to-1. The constant current loop may have a current of substantially 2.8 amps supplied to each of the plurality of interfaces. Each of the interfaces may comprise a respective transformer means and a rectifier means having input terminals coupled to a secondary winding of the transformer means. The interfaces may comprise a respective means for smoothing a voltage output from the rectifier means. The means for smoothing may comprise a capacitor. The interfaces may comprise a respective lightning protection means coupled in parallel with the light emitting diode fixtures coupled thereto. The lightning protection means may be selected from the group consisting of a metal oxide varistor, a transient voltage suppression diode, and a spark gap.

In accordance with another embodiments a method of driving an airfield lighting system comprising powering a constant current loop with a current source, removeably coupling a plurality of interface devices in series with the constant current loop, and removeably coupling a plurality of light emitting diode fixtures with a respective interface device of the plurality of interface devices is provided. The plurality of interface devices may step down a current of the constant current loop to an amperage suitable for driving a respective light emitting diode fixture. The method may further comprise electrically coupling a constant current regulator with the constant current loop. The method may further comprise providing a respective transformer to each of the plurality of interface devices. The method may further comprise electrically coupling the transformer with the constant current loop. The transformer may comprise a turns ratio of substantially 5.6-to-1. The method may further comprise providing a current of substantially 2.8 amps to each of the plurality of interface devices. Each of the plurality of interface devices may comprise a respective transformer and a rectifier, and input terminals of the rectifier may be coupled with a secondary winding of the transformer. The method may further comprise providing each of the plurality of interface devices with a respective smoothing device coupled across terminals of the rectifiers wherein the smoothing device is adapted to smooth a voltage output from the rectifier. The smoothing device may comprises a capacitor. The method may further comprise providing each of the plurality of interface devices with a respective lightning protection device coupled in parallel with the light emitting diode fixture coupled thereto. The lightning protection device may be selected from the group consisting of a metal oxide varistor, a transient voltage suppression diode, and a spark gap.

In accordance with another embodiment, an airfield lighting system comprising a constant current regulator, a constant current loop coupled with the constant current regulator, a plurality of interface devices removeably coupled in series with the constant current loop, wherein each of the plurality of interface devices comprises a respective transformer having a turns ratio of substantially 5.6-to-1, a rectifier coupled across a secondary winding of the transformer and output terminals, and wherein the plurality of interface devices are removeably coupled with the constant current loop with L-824 connectors, and a plurality of light emitting diode fixtures removeably coupled with a respective interface device at the output terminals of the interface device is provided. The light emitting diode fixtures may be coupled with the interface devices by L-823 connectors.

In accordance with another embodiment, an airfield lighting system comprising a means for regulating a constant current, a current loop means for conducting the constant current provided by the means for regulating the constant current, a plurality of interface means removeably coupled in series with the current loop, wherein each of the plurality of interface means comprise a respective transformer means having a turns ratio of substantially 5.6-to-1, a rectifier means coupled across a secondary winding of the transformer means and means for outputting a current from the interface device, and wherein the plurality of interface means are removeably coupled with the constant current loop with L-824 connectors, and a means for removeably coupling a plurality of light emitting diode fixtures with a respective interface device at the means for outputting the current is provided. The light emitting diode fixtures may be coupled with the interface devices by L-823 connectors.

In accordance with another embodiment, a method of driving an airfield lighting system comprising providing a current source to a constant current loop, providing an isolation and step down device that isolates a fixture from the constant current loop and provides a step down of a supply current of the constant current loop providing full wave rectification of an output of the isolation and step down device to produce a direct current from the full wave rectification, smoothing an output of the full wave rectification, providing lightning protection that shunts a current resulting from a transient voltage applied to the interface and providing an output of the interface adapted to couple with the light emitting diode is provided.

It is understood that other variations may be made in the foregoing without departing from the scope of the disclosure. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

1. An airfield lighting system, comprising:
a constant current loop coupled with a current source;
a plurality of interface devices removeably coupled in series with the constant current loop; and
a plurality of light emitting diode fixtures removeably coupled with a respective interface device of the plurality of interface devices, wherein the plurality of interface devices step down a current of the constant current loop to an amperage suitable for driving a respective light emitting diode fixture.

2. The system of claim 1, further comprising a constant current regulator that drives the constant current loop.

3. The system of claim 1, wherein each of the plurality of interface devices respectively includes a transformer.

4. The system of claim 3 wherein the transformer is adapted to electrically couple with the constant current loop.

5. The system of claim 3, wherein the transformer comprises a turns ratio of substantially 5.6-to-1.

6. The system of claim 1, wherein the constant current loop has a current of substantially 2.8 amps supplied to each of the plurality of interface devices.

7. The system of claim 1, wherein each of the plurality of interface devices comprise a respective transformer and a rectifier having input terminals coupled to a secondary winding of the transformer.

8. The system of claim 7, wherein each of the plurality of interface devices comprise a respective smoothing device coupled across terminals of the rectifier, wherein the smoothing device is adapted to smooth a voltage output from the rectifier.

9. The system of claim 8, wherein the smoothing device comprises a capacitor.

10. The system of claim 1, wherein each of the plurality of interface devices comprise a respective lightning protection device coupled in parallel with the light emitting diode fixture coupled thereto.

11. The system of claim 10, wherein the lightning protection device is selected from the group consisting of a metal oxide varistor, a transient voltage suppression diode, and a spark gap.

12. An airfield lighting system, comprising:
means for providing a current to a constant current loop;
means for removeably coupling interfaces in series with the constant current loop; and
means for removeably coupling a plurality of light emitting diode fixtures with the interfaces, wherein the interfaces step down a current of the constant current loop to an amperage suitable for driving a respective light emitting diode fixture.

13. The system of claim 12, further comprising a means that regulates a current of the constant current loop.

14. The system of claim 12, wherein each of the interfaces respectively includes a transformer means.

15. The system of claim 14, wherein the transformer means is adapted to electrically couple with the constant current loop.

16. The system of claim 14, wherein the transformer means comprises a turns ratio of substantially 5.6-to-1.

17. The system of claim 12, wherein the constant current loop has a current of substantially 2.8 amps supplied to each of the plurality of interfaces.

18. The system of claim 12, wherein each of the interfaces comprise a respective transformer means and a rectifier means having input terminals coupled to a secondary winding of the transformer means.

19. The system of claim 18, wherein the interfaces comprise a respective means for smoothing a voltage output from the rectifier means.

20. The system of claim 19, wherein the means for smoothing comprises a capacitor.

21. The system of claim 12, wherein the interfaces comprise a respective lightning protection means coupled in parallel With the light emitting diode fixtures coupled thereto.

22. The system of claim 12, wherein the lightning protection means is selected from the group consisting of a metal oxide varistor, a transient voltage suppression diode, and a spark gap.

23. A method of driving an airfield lighting system, comprising:
powering a constant current loop with a current source;
removeably coupling a plurality of interface devices in series with the constant current loop; and
removeably coupling a plurality of light emitting diode fixtures with a respective interface device of the plurality of interface devices, wherein the plurality of interface devices step down a current of the constant current loop to an amperage suitable for driving a respective light emitting diode fixture.

24. The method of claim 23, further comprising electrically coupling a constant current regulator with the constant current loop.

25. The method of claim 23, further comprising providing a respective transformer to each of the plurality of interface devices.

26. The method of claim 25, further comprising electrically coupling the transformer with the constant current loop.

27. The method of claim 25, wherein the transformer comprises a turns ratio of substantially 5.6-to-1.

28. The method of claim 23, further comprising providing a current of substantially 2.8 amps to each of the plurality of interface devices.

29. The method of claim 23, wherein each of the plurality of interface devices comprise a respective transformer and a rectifier, the method further comprising coupling input terminals of the rectifier with a secondary winding of the transformer.

30. The method of claim 29, further comprising providing each, of the plurality of interface devices with a respective smoothing device coupled across terminals of the rectifier, wherein the smoothing device is adapted to smooth a voltage output from the rectifier.

31. The method of claim 30, wherein the smoothing device comprises a capacitor.

32. The method of claim 23, further comprising providing each of the plurality of interface devices with a respective lightning protection device coupled in parallel with the light emitting diode fixture coupled thereto.

33. The method of claim 32, wherein the lightning protection device is selected from the group consisting of a metal oxide varistor, a transient voltage suppression diode, and a spark gap.

34. An airfield lighting system, comprising:
a constant current regulator;
a constant current loop coupled with the constant current regulator;
a plurality of interface devices removeably coupled in series with the constant current loop, wherein each of the plurality of interface devices comprise a respective transformer having a turns ratio of substantially 5.6-to-one, a rectifier coupled across a secondary winding of the transformer and output terminals, and wherein the plurality of interface devices are removeably coupled with the constant current loop with L-824 connectors; and
a plurality of light emitting diode fixtures removeably coupled with a respective interface device at the output terminals of the interface device, wherein the light emitting diode fixtures are coupled with the interface devices by L-823 connectors.

35. An airfield lighting system, comprising:
a means for regulating a constant current;
a current loop means for conducting the constant current provided by the means for regulating the constant current;
a plurality of interface means removeably coupled in series with the current loop wherein each of the plurality of interface means comprise a respective transformer means having a turns ratio of substantially 5.6-to-one, a rectifier means coupled across a secondary winding of the transformer means and means for outputting a current from the interface device and wherein the plurality of interface means are removeably coupled with the constant current loop with L-824 connectors; and
a means for removeably coupling a plurality of light emitting diode fixtures with a respective interface device at the means for outputting the current, wherein the light emitting diode fixtures are coupled with the interface devices by L-823 connectors.

36. A method of driving an airfield lighting systems comprising:
providing a current source to a constant current loop;
providing an isolation and step down device that isolates a fixture from the constant current loop and provides a step down of a supply current of the constant current loop;
providing full wave rectification of an output of the isolation and step down device to produce a direct current from the full wave rectification;
smoothing an output of the full wave rectification;
providing lightning protection that shunts a current resulting from a transient voltage applied to the interface; and
providing an output of the interface adapted to couple with a light emitting diode.
